(19) United States
(12) Patent Application Publication
(10) Pub. No.: US 2026/0227570 A1
(43) Pub. Date: Aug. 6, 2026

(54) FIBER COUPLER CHIP

(71) Applicant: PsiQuantum, Corp., Palo Alto, CA (US)

(72) Inventors: Eric F. Dudley, Palo Alto, CA (US); Mihai Dorian Vidrighin, London (GB)

(21) Appl. No.: 19/149,404

(22) PCT Filed: Jan. 19, 2024
(86) PCT No.: PCT/US2024/012267

§ 371 Date: Jul. 18, 2025

Related U.S. Application Data
(60) Provisional application No. 63/440,362, filed on Jan. 20, 2023.

(51) Int. Cl. G02B 6/14; G02B 6/122

(52) U.S. Cl. CPC G02B 6/14; G02B 6/1228

(57) ABSTRACT

A fiber coupler chip can receive light coupled from a plurality of fibers. The fiber coupler chip can reduce a mode size of the light from a. larger size of the fiber to smaller waveguide size using a mode converters or other components. The fiber coupler chip can couple the light using free space coupling to a photonic integrated circuit, where the interface is mode matched waveguide-to-waveguide low loss coupling.

### CLAIM OF PRIORITY

This application claims priority to and the benefit of U.S. Provisional Patent Application No. 63/440,362, filed on Jan. 20, 2023, the contents of which are incorporated herein by reference in its entirety.

### TECHNICAL FIELD

The present disclosure generally relates to an optical coupler, and more particularly, to a fiber coupler chip.

### BACKGROUND

A photonic device can comprise waveguides that direct light. A first waveguide can couple light into a second waveguide, however optical loss can occur which can lower the performance of various photonic designs. Further, for some applications, such as high-performance quantum optics-based communications and quantum logic devices, optical issues can arise in coupled transitions (e.g., chip to chip, fiber to chip) can cause failure of the device to operate.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, or characteristic included in at least one implementation of the inventive subject matter. Thus, phrases such as “in one embodiment” or “in an alternate embodiment” appearing herein describe various embodiments and implementations of the inventive subject matter, and do not necessarily all refer to the same embodiment. However, they are also not necessarily mutually exclusive. To easily identify the discussion of any particular element or act, the most significant digit or digits in a reference number refer to the figure (“FIG.”) number in which that element or act is first introduced.

FIG. 1 shows a photonic switch-based information processing system, according to some example embodiments.

FIGS. 2A-2C show example quantum light switch architectures, according to some example embodiments.

FIG. 3 illustrates an example fabrication stack of a photonic integrated circuit wafer including various photonic integrated circuit components, according to some example embodiments.

FIG. 4 illustrates the optical switch implemented as a generalized Mach-Zehnder interferometer, in accordance with some example embodiments.

FIG. 5 shows a fiber chip coupler (FCC) system, in accordance with some example embodiments.

FIG. 6 shows a fiber chip coupler system, in accordance with some example embodiments.

FIG. 7 shows a lateral alignment architecture, in accordance with some example embodiments.

FIG. 8 shows a vertical alignment architecture, in accordance with some example embodiments.

FIG. 9 shows a flow diagram of a method for coupling light from a fiber coupler chip to a photonic integrated circuit, in accordance with some example embodiments.

Descriptions of certain details and implementations follow, including a description of the figures, which may depict some or all of the embodiments described below, as well as discussing other potential embodiments or implementations of the inventive concepts presented herein. An overview of embodiments of the disclosure is provided below, followed by a more detailed description with reference to the drawings.

### DETAILED DESCRIPTION

In the following description, for the purposes of explanation, numerous specific details are set forth to provide an understanding of various embodiments of the inventive subject matter. It will be evident, however, to those skilled in the art, that embodiments of the inventive subject matter may be practiced without these specific details. In general, well-known instruction instances, structures, and techniques are not necessarily shown in detail.

It can be difficult to edge couple light from a fiber optic cable to a waveguide of a photonic integrated circuit. The mode size of a fiber optic is much larger than the waveguide mode size and mode size mismatch can degrade optical coupling performance. Further, it can be difficult or not practical in a given photonic circuit to integrate fiber coupling mechanisms into the PIC. For example, a PIC may be formed for a particular purpose and have small waveguides and very thin layers (e.g., thin layers of buried oxide (BOX)) that are incongruent with fiber PIC components (that may have thick BOX layers to compensate for the large fiber mode size). Additionally, the manufacturing processes of the fibers and components (e.g., fusing or melting fibers, high temperature anneals) may also be incongruent with a given PIC into which fiber light is to be coupled. For example, the fiber-based components may require high temperature anneals during manufacturing (e.g., 450 C, 1200 C) that would be incongruent with the components of the PIC (e.g., degrade performance, render the PIC components inoperable).

To address the forgoing, a fiber coupler chip can be connected to a plurality of fibers, where the fiber coupler chip can undergo separate manufacturing processing than the PICS to which the fiber coupler chip couples light. The fiber coupler chip can include input ports having a mode sizes that are of the fiber size, and the output ports that match the mode size to the waveguide mode size of input ports of a coupled-to PIC. Due to the mode size of the fiber coupler output port being of waveguide size and matching the input port PIC waveguide size, the mode matching is highly performant. In some example embodiments, the matching of the mode sizes may create potential for misalignment issues between the fiber coupler chip output ports and the input ports of a coupled-to PIC. In some example embodiments, the mode size the coupling interface is expanded using mode expanders in the fiber coupler chip and corresponding (e.g., reverse oriented) mode expanders in the PIC. The increased mode sizes at the coupling interface reduces alignment sensitivity at the FCC to PIC interface. For example, the misalignment tolerance can scale with mode size (e.g., enlarging the mode by two reduces misalignment issues by half, as the small misalignments of the large mode overlaps are more blurred out, so to speak). In some example embodiments, the alignment of the FCC to the PIC is addressed using adiabatic couplers at the FCC to PIC interface, instead of mode expanders. In some example embodiments, the FCC and PIC have congruent lateral features for passive x-alignment, and vertical registration features (e.g., vertical lock and key features) for passive y-alignment.

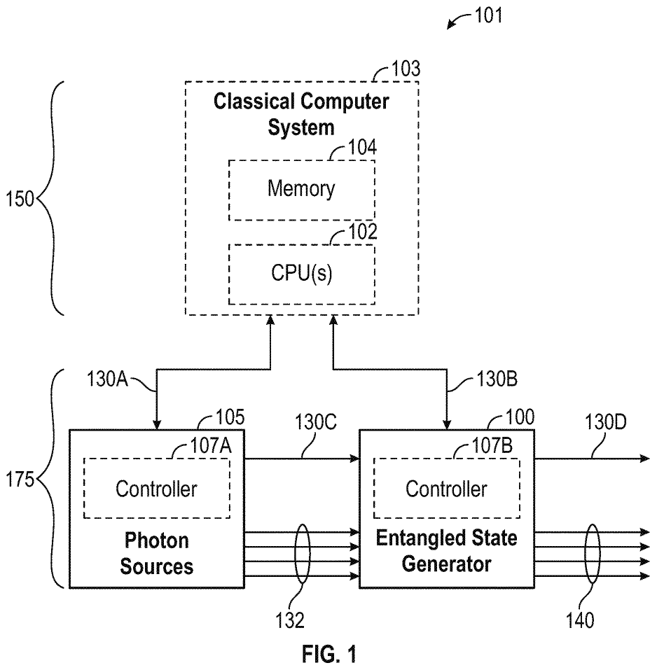

FIG. 1 shows a hybrid information processing system 101, according to some example embodiments. As illustrated, the hybrid information processing system 101 comprises an electronic information processing architecture 150 and a photonic processing architecture 175 that processes information optically. At a high-level, the electronic information processing architecture 150 processes information electronically (e.g., binary data processing in a circuit, an ASIC, or with one or more central processing units and memory that stores instructions), and the photonic processing architecture 175 that processes information optically (e.g., classical light information processing such as PAM, PSK, QAM signaling of light beams, or non-classical light information processing that uses extremely low levels of light, such as single photon or entangled photon processing and detection).

The hybrid information processing system 101 can be used to generate qubits (e.g., photons) in an entangled state (e.g., a GHZ state, Bell pair state, and the like), in accordance with some embodiments. In an illustrative photonic architecture, hybrid information processing system 101 can include a photon source module 105 that is optically connected to entangled state generator 100. Both the photon source module 105 and the entangled state generator 100 may be coupled to a classical computing system 103 such that the classical computing system 103 can communicate and/or control (e.g., via the classical information channels 130Ab) the photon source module 105 and/or the entangled state generator 100. Photon source module 105 may include a collection of single-photon sources that can provide output photons to entangled state generator 100 by way of interconnecting waveguides 132. Entangled state generator 100 may receive the output photons and convert them to one or more entangled photonic states and then output these entangled photonic states into output waveguides 140. In some embodiments, output waveguide 140 can be coupled to some downstream circuit that may use the entangled states for performing a quantum computation. For example, the entangled states generated by the entangled state generator 100 may be used as resources for a downstream quantum optical circuit (not shown).

In some embodiments, the hybrid information processing system 101 may include classical channels 130 (e.g., classical channels 130A through 130D) for interconnecting and providing classical information between components. It should be noted that classical channels 130A through 130D need not all be the same. For example, classical channel 130A through 130C may comprise a bi-directional communication bus carrying one or more reference signals, e.g., one or more clock signals, one or more control signals, or any other signal that carries classical information, e.g., beralding signals, photon detector readout signals, and the like.

In some example embodiments, the hybrid information processing system 101 includes the classical computing system 103 that communicates with and/or controls the photon source module 105 and/or the entangled state generator 100. For example, in some embodiments, classical computing system 103 can be used to configure one or more circuits, e.g., using system clock that may be provided to the photon source module 105 and the entangled state generator 100 as well as any downstream quantum photonic circuits used for performing quantum computation. In some embodiments, the quantum photonic circuits can include optical circuits, electrical circuits, or any other types of circuits. In some embodiments, classical computing system 103 includes memory 104, one or more processor(s) 102, a power supply, an input/output (I/O) subsystem, and a communication bus or interconnecting these components. The processor(s) 102 may execute modules, programs, and/or instructions stored in memory 104 and thereby perform processing operations.

In some embodiments, memory 104 stores one or more programs (e.g., sets of instructions) and/or data structures. For example, in some embodiments, entangled state generator 100 can attempt to produce an entangled state over successive stages, any one of which may be successful in producing an entangled state. In some embodiments, memory 104 stores one or more programs for determining whether a respective stage was successful and configuring the entangled state generator 100 accordingly (e.g., by configuring entangled state generator 100 to switch the photons to an output if the stage was successful or pass the photons to the next stage of the entangled state generator 100 if the stage was not yet successful). To that end, in some embodiments, memory 104 stores detection patterns (described below) from which the classical computing system 103 may determine whether a stage was successful. In addition, memory 104 can store settings that are provided to the various configurable components (e.g., switches) described herein that are configured by, e.g., setting one or more phase shifts for the component.

In some embodiments, some or all of the above-described functions may be implemented with hardware circuits on photon source module 105 and/or entangled state generator 100. For example, in some embodiments, photon source module 105 includes one or more controllers 107A (e.g., logic controllers) (e.g., which may comprise field programmable gate arrays (FPGAs), application specific integrated circuits (ASICS), a “system on a chip” that includes classical processors and memory, or the like). In some embodiments, controller 107A determines whether photon source module 105 was successful (e.g., for a given attempt on a given clock cycle, described below) and outputs a reference signal indicating whether photon source module 105 was successful. For example, in some embodiments, controller 107A outputs a logical high value to classical channel 130A and/or classical channel 130C when photon source module 105 is successful and outputs a logical low value to classical channel 130A and/or classical channel 130C when photon source module 105 is not successful. In some embodiments, the output of controller 107A may be used to configure hardware in controller 107B.

Similarly, in some embodiments, entangled state generator 100 includes one or more controllers 107B (e.g., logical controllers) (e.g., which may comprise field programmable gate arrays (FPGAs), application specific integrated circuits (ASICS), or the like) that determine whether a respective stage of entangled state generator 100 has succeeded, perform the switching logic described above, and output a reference signal to classical channels 130B and/or 130D to inform other components as to whether the entangled state generator 100 has succeeded.

In some embodiments, a system clock signal can be provided to photon source module 105 and entangled state generator 100 via an external source (not shown) or by classical computing system 103 generates via classical channels 130A and/or 130B. In some embodiments, the system clock signal provided to photon source module 105 triggers the photon source module 105 to attempt to output one photon per waveguide. In some embodiments, the system clock signal provided to entangled state generator 100 triggers, or gates, sets of detectors in entangled state generator 100 to attempt to detect photons. For example, in some embodiments, triggering a set of detectors in entangled state generator 100 to attempt to detect photons includes gating the set of detectors.

It should be noted that, in some embodiments, photon source module 105 and entangled state generator 100 may have internal clocks. For example, photon source module 105 may have an internal clock generated and/or used by controller 107A and entangled state generator 100 has an internal clock generated and/or used by controller 107B. In some embodiments, the internal clock of photon source module 105 and/or entangled state generator 100 is synchronized to an external clock (e.g., the system clock provided by classical computing system 103) (e.g., through a phase-locked loop). In some embodiments, any of the internal clocks may themselves be used as the system clock, e.g., an internal clock of the photon source may be distributed to other components in the system and used as the master/system clock.

In some embodiments, photon source module 105 includes a plurality of probabilistic photon sources that may be spatially and/or temporally multiplexed (e.g., multiplexed single photon source). In one example of such a source, the source is driven by a pump, e.g., a light pulse, that is coupled into an optical resonator that, through some nonlinear process (e.g., spontaneous four wave mixing, second harmonic generation, and the like) may generate zero, one, or more photons. As used herein, the term “attempt” is used to refer to the act of driving a photon source with some sort of driving signal, e.g., a pump pulse, that may produce output photons non-deterministically (e.g., in response to the driving signal, the probability that the photon source will generate one or more photons may be less than 1). In some embodiments, a respective photon source may be most likely to, on a respective attempt, produce zero photons (e.g., there may be a 90% probability of producing zero photons per attempt to produce a single photon). The second most likely result for an attempt may be production of a single-photon (e.g., there may be a 9% probability of producing a single-photon per attempt to produce a single-photon). The third most likely result for an attempt may be production of two photons (e.g., there may be an approximately 1% probability of producing two photons per attempt to produce a single photon). In some circumstances, there may be less than a 1% probability of producing more than two photons.

In some embodiments, the apparent efficiency of the photon sources may be increased by using a plurality of single-photon sources and multiplexing the outputs of the plurality of photon sources.

The precise type of photon source used is not critical and any type of source can be used, employing any photon generating process, such as spontaneous four wave mixing (SPFW), spontaneous parametric down-conversion (SPDC), or any other process. Other classes of sources that do not necessarily require a nonlinear material can also be employed, such as those that employ atomic and/or artificial atomic systems, e.g., quantum dot sources, color centers in crystals, and the like. In some cases, sources may or may be coupled to photonic cavities, e.g., as can be the case for artificial atomic systems such as quantum dots coupled to cavities. Other types of photon sources also exist for SPWM and SPDC, such as optomechanical systems and the like. In some examples the photon sources can emit multiple photons already in an entangled state in which case the entangled state generator 100 may not be necessary, or alternatively may take the entangled states as input and generate even larger entangled states.

For the sake of illustration, an example which employs spatial multiplexing of several non-deterministic is described as an example of a mux photon source. However, many different spatial mux architectures are possible without departing from the scope of the present disclosure. Temporal muxing can also be implemented instead of or in combination with spatial multiplexing. Mux schemes that employ log-tree, generalized Mach-Zehnder interferometers, multimode interferometers, chained sources, chained sources with dump-the-pump schemes, asymmetric multi-crystal single photon sources, or any other type of mux architecture can be used. In some embodiments, the photon source can employ a mux scheme with quantum feedback control and the like.

The foregoing description provides an example of how photonic circuits can be used to implement physical qubits and operations on physical qubits using mode coupling between waveguides. In these examples, a pair of modes can be used to represent each physical qubit. Examples described below can be implemented using similar photonic circuit elements.

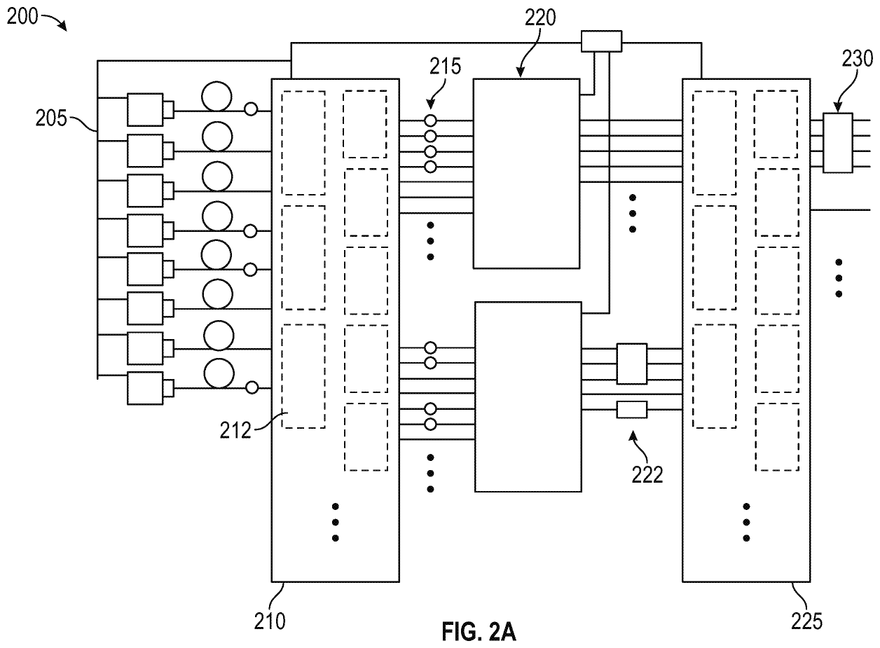

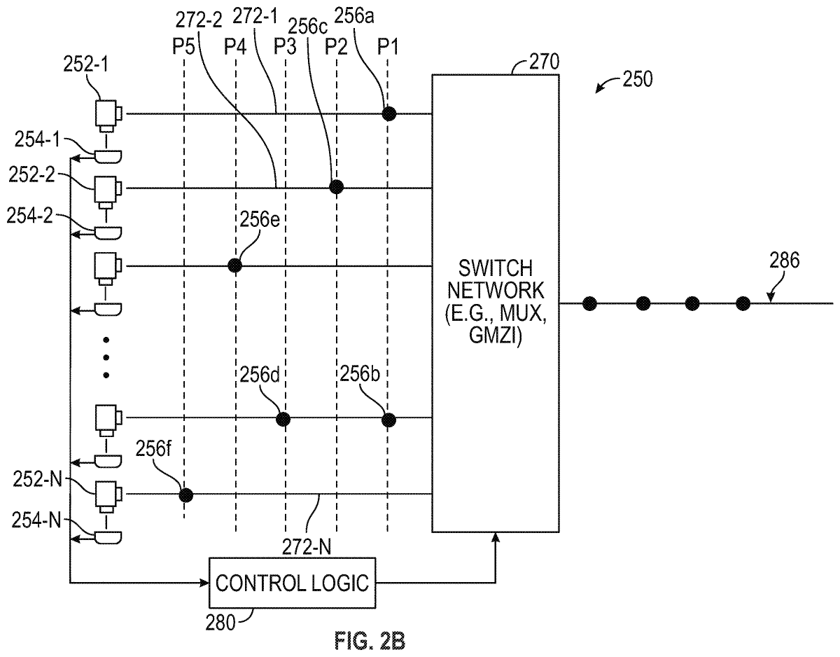

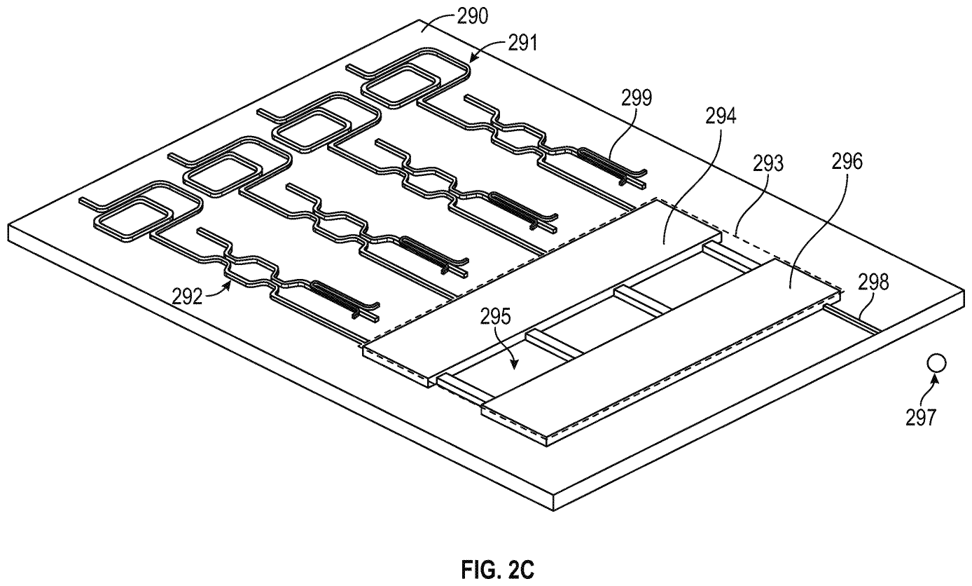

FIG. 2A shows a photonic processing architecture 200 of the hybrid information processing system 101, according to some example embodiments. In the example of FIG. 2A, the architecture 200 is configured as a spatial multiplexing architecture, although it is appreciated that in other example embodiments the photonic architecture is configured for time-based multiplexing that implement time-binned entanglement using switches (e.g., GMZIs). In the example of FIG. 2A, a plurality of optical sources 205 comprise a set of probabilistic optical sources that generate single photons probabilistically (e.g., spontaneous parametric down conversion, four wave mixing, quantum dot generated single photons). In some example embodiments, the plurality of optical sources 205 generate pairs of photons and one or more photons in the pairs are detected (e.g., herald photons) to indicate that a successful entangle-able photon has been transmitted towards the switch network 210. In some example embodiments, the detected heralded photons generate source success or fail data bits that are electronically input into the switch network 210 to enable the switch network 210 to route groups of the enable-able photons 215 to a photonic entanglement circuit 220 for entanglement. The photonic entanglement circuit 220 receives the entangle-able photons and generates entanglement qubits 230 (e.g., photonic resource states comprising three or more entangled photons). In some example embodiments, like the plurality of optical sources 205, the photonic entanglement circuit 220 functions probabilistically and successful generation of entanglement groups 222 occurs infrequently. In some example embodiments, the photonic entanglement circuit 220 implements one or more optical detections of photons in the photonic entanglement circuit 220 to generate circuit success or fail data that indicates whether a successful entanglement of a group has occurred and further indicates the location of the entangled portions of a given entanglement group 222. The circuit success or fail data is electronically communicated to a second switch network 225 for further routing. In some example embodiments, the second switch network 225 performs further entanglement operations by merging the entangled photons without detection or otherwise decoherence, such that the switch network outputs one or more entanglement qubits 230 for further non-classical optical processing (e.g., quantum communication, quantum experimentation of quantum states, quantum computing). In some example embodiments, the switch network 210, the photonic entanglement circuit 220, and the second switch network 225 implement optical switches, such as optical switch chip 212, to perform both routing and production of photonic entanglements. In some example embodiments, the optical switch chip 212 comprises a generalized Mach-Zehnder 10nterferometer, as discussed in further detail below.

In some example embodiments, a Mach Zehnder interferometer comprises a being splitter that divides an input light into two equal parts which travel on different paths and then combined back together again on a second beam splitter. The path length can be adjusted between the two arms can be adjusted such that the phase difference of classical light input into the Mach Zehnder interferometer can cause all of the light to be output from a single output port. In some example embodiments, the path links of the different arms are not adjusted but rather physical characteristics of one or more of the arms are modified to implement phase shifts of light traversing the given arm, thereby enabling the direction of the input light to a single output port were both output ports. When classical or “bright light” is input into a given Mach-Zehnder interferometer the device can function as a splitter or guide that guides the classical light towards one or more of the output ports. Interestingly, when non-classical light (e.g., single photons, quantum light) is input into an MZI, the photon is split and propagates as a super position of being in each arm at the same time as a propagates through the device. As an example, if the MZI is in a 50/50 splitter configuration (e.g., via path length or active phase adjustments), the super position of the single photon of quantum light is recombined at the second splitter and there is a 50/50 chance of emerging from either output port. Thus, the MZI can function as a classical and non-classical (e.g., quantum) photonic device.

FIG. 2B show an example source architecture 250, in accordance with some example embodiments. The source architecture 250 is an example time-bin switch architecture for increasing a probability of photon generation using non-deterministic sources (e.g., the plurality of optical sources 205, FIG. 2A) and a switch network 270 (e.g., the switch network 210, FIG. 2A, one or more GMZIs). One technique to improve the likelihood of simultaneously obtaining photons from each of a set of non-deterministic photon sources involves spatial multiplexing of multiple photon sources. The architecture 250 is configured as a N×1 (or N-to-1) multiplexing circuit for a set of N photon sources 252-1 through 252-N (e.g., plurality of optical sources 205) for some number N, where N≥2. In some example embodiments, each photon source 252 is a different physical device that can produce a photon pair in response to a pump pulse (e.g., laser pump pulse). For instance, each photon source 252 can be a heralded single photon source as described above. Photon sources 252 can be pumped repeatedly, and each instance of the photon sources 252 (e.g., pump sources) can define a time bin (or temporal mode). For each time bin, each photon source 252 might or might not produce a photon pair. Each photon source 252 has an associated detector 254 and an associated signaling waveguide 272. In some example embodiments, in any time bin where a particular photon source 252 does produce a photon pair, one photon propagates through the associated signaling waveguide 272 while the other photon is detected by the associated detector 254.

In each time bin, each photon source 252 might or might not generate a photon. Dots 256a-256f show an example of photons that might be generated during different time bins P1-P5. FIG. 2B can be regarded as a snapshot view, with photons 256 produced during different time bins appearing at different locations along the waveguides 272 of different waveguide arms.

In some example embodiments, the switch network 270 is implemented as a N×1 multiplexer (or “mux”) that operates as an active optical switching circuit that selectably couples one of N input waveguides 272 to an output waveguide 286. In some example embodiments, selectable optical coupling can be provided using active optical switches or other active optical components that can be controlled to either allow or block propagation of photons. For example, a N×1 mux in the switch network 270 can be implemented as an N×1 generalized Mach-Zehnder interferometer (GMZI). In some example embodiments, an N×M (or N-to-M) GMZI is an optical circuit that can receive photons on a set of N input waveguides and control a set of active phase shifters to selectably couple M of the received photons to a set of M output waveguides. In some example embodiments, one or more of the phase shifters may be passive fixed phase shifters for preconfigured phase shifts, as discussed in further detail below with reference to FIG. 2B. In the example of FIG. 2B, the switch network is configured as a M=1 multiplexer that has one output. In some example embodiments, the N×1 mux of the switch network 270 can be controlled by control logic 280 (e.g., controllers), which can be implemented using a conventional electronic logic circuit. In some example embodiments, control logic 280 can receive signals from each of detectors 254 that indicate, for each time bin, whether a photon was or was not detected by each detector 254. Accordingly, control logic 280 can determine which photon sources 252 produced photons during a given time bin (and therefore which input waveguides that are coupled to the switch network 270 are carrying photons for that time bin). For each time bin, control logic 280 can control the switch network 270 to couple one input waveguide that has a photon to output waveguide 286. For example, a GMZI includes a set of active phase shifters that can be controlled to apply variable phase shifts along different optical paths, creating either constructive or destructive interference, and control logic 280 can generate control signals to set the state of each active phase shifter in a GMZI implementing N×1 mux to provide the desired coupling.

In some example embodiments, the time bin can be as long or short as desired, based on characteristics of the optical circuit, variability in the timing of generating photons in the photon sources 252, and so on. In some instances, an interval between time bins may be determined based on the speed at which N×1 mux operations in the switch network 270 can be switched, on a recovery time for photon sources 252 and/or detectors 254, operating speed of circuits downstream of the switch network 270, or other design considerations to allow each time bin to be treated as an independent temporal mode.

As noted above, the behavior of photon sources 252 may be non-deterministic. That is, during a given time bin, the probability of a photon being generated by a given photon source 252 can be represented as ps, where p_s<1. For photon sources of this type, multiplexing as shown in FIG. 2B provides the ability to increase the probability of successfully producing a photon in a given time bin. As shown in FIG. 2B, if N non-deterministic single-photon sources are used, with one photon source coupled to each input of the switch network 270, and if each photon source has probability ps of generating a photon (for a given time bin), then the probability that the switch network 270 receives at least one photon is p_mux=1−(1−p_s)\hat{ }N. Thus, for a given type of photon source 252, a desired probability pmux of providing one photon per time bin to output waveguide 286 can, at least in principle, be achieved by a suitable choice of N. Although it is appreciated, as a practical matter, some combinations of ps and pmux may require a prohibitively large number N of photon sources.

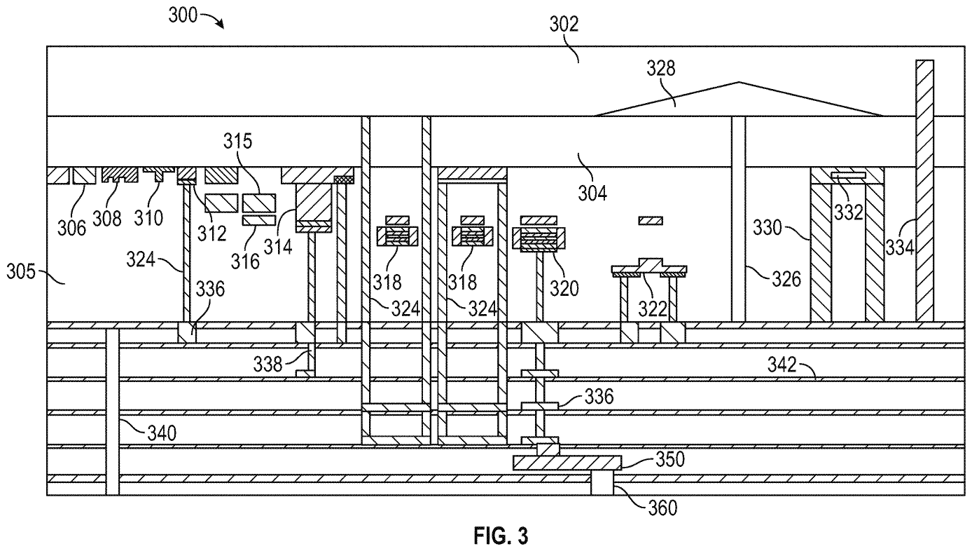

FIG. 2C shows an example of a single photon source photonic integrated circuit (PIC) 290, in accordance with some example embodiments. The embodiment of FIG. 2C is an example of a single chip that can implement the architecture 250 of FIG. 2B discussed above. FIG. 3 shows example fabrication stack that can be implemented to fabricate the different components shown in the single photon source PIC 290 using existing semiconductor fabrication processes, in accordance with some example embodiments. The single photon source PIC 290 can be formed from one or more of: silicon nitride, indium phosphide, and III-V material. As illustrated in FIG. 2C, the single photon source PIC 290 comprises a photon source array 291 that generates photons non-deterministically. In some example embodiments, each source in the array 291 comprises a ring resonator and a MZI where an upper portion of the ring resonator functions as the lower arm of the MZI. In some example embodiments, each source in the array 291 receives pump light and implements one or more single photon source schemes (e.g., spontaneous four wave mixing, spontaneous parametric down conversion) to non-deterministically generate single photons. In some example embodiments, each source in the array comprises a single input and a single output that is coupled to a filter. Each source outputs the pump light and one or more photon pairs into a filter array 292 for filtering. In some example embodiments, each filter in the filter array 292 is configured as a pump rejection filter to filter out pump light such that only photon pairs are output from the filter array 292. In some example embodiments, one of the photons from each filter impinges on a herald detector to indicate that its counterpart photon (e.g., signal photon) exists and is propagating towards the switch 293. As discussed in further detail below, the switch 293 can include a first quantum optical coupler network 294 (e.g., Hadamard network) that separates the quantum light onto a plurality of waveguide arms and a second quantum optical coupler network 296 that combines the quantum light in such a way (e.g., via interference) that the quantum light 297 (e.g., single photon) is output from a single output waveguide 298. In some example embodiments, the switch 293 comprises electro-optical material (e.g., BTO, discussed below) that can change the phase of the light on one or more of the given arms to implement a N-to-1 permutation, as discussed in further detail below.

FIG. 3 illustrates an example fabrication stack of a PIC wafer 300 including various photonic integrated circuit components according to certain embodiments. In the illustrated example, PIC wafer 300 includes a substrate 302, an oxide layer 305, a buried oxide layer (BOX) layer 304, a temperature sensor 306, a grating coupler 308, a ridge waveguide 310, a heater 312, a Ge photodiode 314, one or more layers of SiN waveguides 315 and 316, one or more super conducting nanowire single photon detectors (SNSPDs) 318 (e.g., a herald detector 299 in FIG. 2B), SNSPD contact regions 320, and the like. As described above, the silicon-based circuit components, such as grating coupler 308, a ridge waveguide 310, temperature sensor 306, and the like, may be formed in an SOI layer deposited on BOX layer 304. SiN waveguides 315 and 316 may have different thicknesses and different losses and may be used to form various active and passive photonic integrated circuit components, such as delay lines, phase shifters, ring oscillator, interferometers, switches, filters, single photon detectors, couplers, and the like. SiN waveguides 315 and 316 may receive light from an optical fiber through edge coupling or grating coupler 308. These devices may be fabricated on a same wafer, in accordance with some example embodiments.

Heater 312 may include, for example, a silicide layer (such as a nickel silicide layer), a nitride layer (e.g., TiN or NbN), or another resistive material layer, and may be used to tune silicon waveguides. The silicide layer may also be formed in other regions, such as on top of a silicon material region in the SOI layer below SNSPD 318, to form part of a scatter mitigation structure. The wafer with these devices and structures may be bonded with a wafer with phase shifters 322 (e.g., electro-optical material 295 in FIG. 2C) for BTO switches formed thereon. The substrate of the wafer with phase shifters 322 may subsequently be removed and the STO layer of phase shifters 322 may be patterned by selective etching.

Electrical contacts 324 (e.g., through-oxide vias) may be formed in the oxide layers to make electrical connections to the various devices, such as heater 312, Ge photodiode 314, SNSPDs 318, phase shifters 322, and the like. As illustrated in the example, electrical contacts 324 may include metal trenches surrounding SNSPDs 318 to form scatter mitigation structures for blocking stray light as described above.

As also illustrated in FIG. 3, thermal trenches 326 and undercut regions 328 may be formed in the oxide layers and substrate 302 respectively. Additionally, or alternatively, thermal isolation trenches 330 and undercut region 332 may be formed by, for example, etching trenches in the oxide layers to expose certain regions of the SOI layer, and then selectively etching the SOI layer to remove the silicon and form an undercut region. In some embodiments, other structures, such as metal trenches 334 may be formed in the oxide layers and the substrate.

After these structures are manufactured, PIC wafer 300 may be processed using the BEOL processes to form one or more metal layers 336 and vias 338 (e.g., metal plugs or metal trenches). Some vias 338 may be aligned with some electrical contacts 324 to form the scatter mitigation structures for SNSPDs 318. In some embodiments, a trench 340 aligned with grating coupler 308 may be etched in the oxide layer to facilitate the coupling of light into the waveguides. For example, an optical fiber may be inserted into trench 340 or positioned on trench 340 to send light to grating coupler 308.

As illustrated in FIG. 3, one or more etch stop layers 342 (e.g., SiCN layers) may be used as needed for etching and patterning the metal layers and other structures. The SiCN layers may also be passivation layers for the metal (e.g., copper) in the metal layers. Contact pads 350 may be formed on the top metal layer (bottom layer shown in FIG. 3) of PIC wafer 300. In the illustrated example, trenches 360 may be etched to from boning balls (not shown in FIG. 3) for bonding contact pads 350 with an EIC wafer.

PIC wafer 300 shown in FIG. 3 includes various passive and active photonic components in a same wafer stack, such as silicon waveguides, SIN waveguides that form parts of other passive or active photonic components (e.g., splitters, filters, delay lines, phase shifters, and single photon sources), grating couplers, Ge photodetectors, single photon detectors, low power BTO phase shifters/switches, temperature sensors, heaters, and the like. Thus, PIC wafer 300 may be used to perform various functions for optical quantum computing, such as single photon generation, photon entanglement, fusion, qubit storage, resource state generation, single-photon and multi-photon measurement, data communication, and the like. PIC wafer 300 also includes thermal isolation structures (e.g., undercut regions 328 and trenches 326) for thermally isolating, for example, the heaters from other components. Undercut regions 328 can be formed in a large region in substrate 302 to thermally isolate components in a large region. Undercut regions (e.g., undercut region 332) may additionally or alternatively be formed in an SOI layer. PIC wafer 300 further includes scattered light mitigation structures formed by metal layers, a silicide layer, and through-oxide vias or trenches, to isolate, for example, the single photon detectors from stray light.

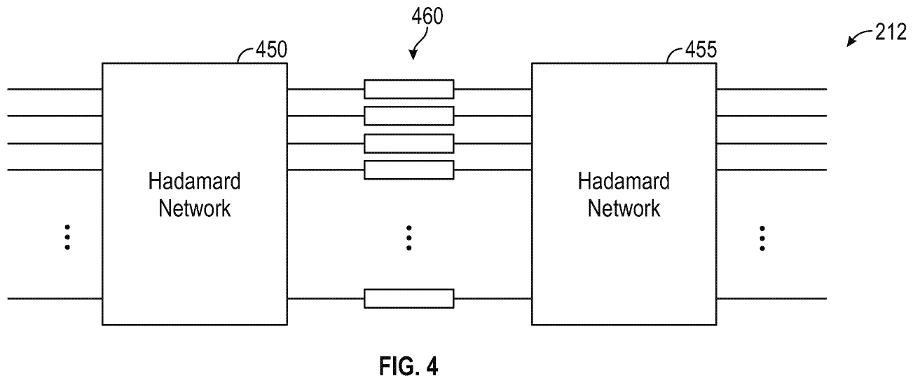

FIG. 4 illustrates the optical switch chip 212 implemented as a generalized MZI (GMZI), in accordance with some example embodiments. The GMZI is an extension of an MZI with N>2 inputs and M_1 outputs, shown in FIG. 4. This configuration allows a set of permutations to be performed on the inputs thereby configuring the switch as a useful block in the design and construction of composite N-to-1 and N-to-M switch networks. In some example embodiments, varying the settings of phase shifters 460 (e.g., active phase shifters) to set specific permutations of the N inputs and routes them to M>1 output ports. There are several spatial mux schemes that select one of multiple inputs from distinct locations in space. For example, a GMZI can be configured as a N-to-1 mux, as it allows routing of any input to a single output port. The advantages of this scheme include low constant active phase shifter depth (e.g., depth=1) and count (N). However, the total propagation distance and the number of waveguide crossings increase rapidly with N.

As illustrated in FIG. 4, the example GMZI comprises a first Hadamard gate 450 or splitter (e.g., etalon, an MMI, a network of directional couplers and waveguide crossings) and a second Hadamard gate 455 or splitter (e.g., etalon, an MMI, a network of directional couplers and waveguide crossings) that split and recombine the light propagating on one or more of a plurality of arms (e.g., eight arms, in an 8×8 GMZI) such that the light is output on one or more of the plurality of output ports. Example architecture for the first Hadamard gate 450 and second Hadamard gate 455 are discussed in further detail below.

In a bright light example, the GMZI can operate as a power splitter that splits the beam onto the output ports in a given configuration according to settings of the phase shifters 460. In the single photon quantum light operation, the GMZI splits superpositions of the quantum light onto the output ports for recombination and output according to settings of the phase shifters 460.

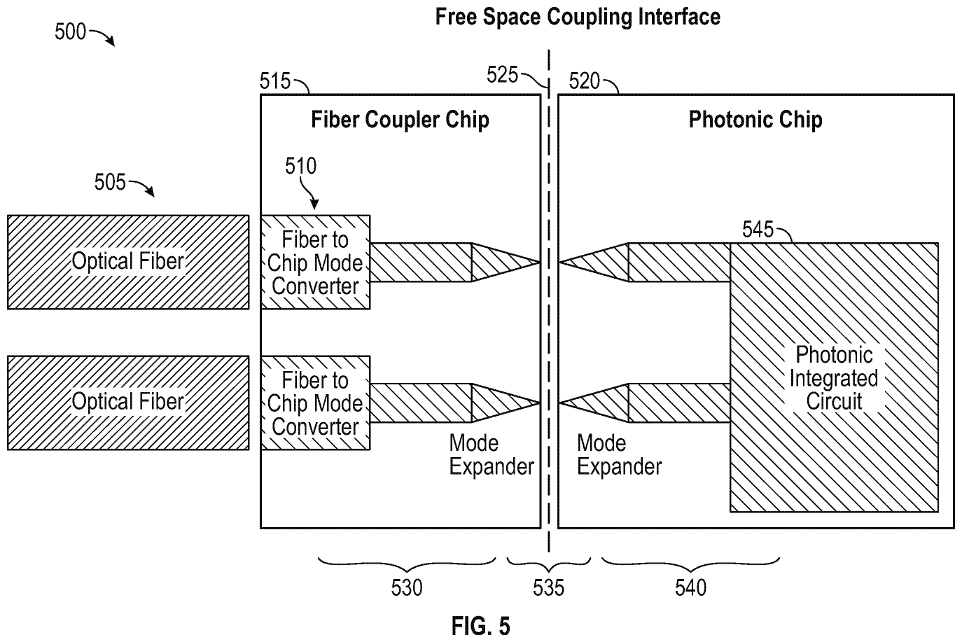

FIG. 5 shows a fiber chip coupling architecture 500, in accordance with some example embodiments. At a high level, the photonic chip 520 can include any photonic circuit discussed above in which light is coupled into the photonic circuit (e.g., from fibers). As an example, the photonic chip 520 can be implemented as optical switch chip 212, where source light is coupled into the optical switch chip 212 using the fiber coupler chip 515 and coupled out of the optical switch chip using another fiber coupler chip (e.g., that couples the light for additional switching or detection of photons).

In the illustrated example of FIG. 5, a plurality of optical fibers 505 are coupled to fiber-to-chip mode converters 510 of a fiber coupler chip 515. The fiber coupler chip 515 can be formed from one or more of: silicon nitride, indium phosphide, and III-V material. The fiber-to-chip mode converters 510 have a physical mode size that is the same as the fiber mode size of the fibers 505 (e.g., large input port, large BOX layer). In some example embodiments, the plurality of optical fibers 505 are physically connected to the fiber coupler chip 515 (e.g., to input ports of the fiber coupler chip) using one or more of: a fiber array unit (FAU), microlens, v-groove arrays, fusing or melting single fibers (e.g., single fibers with alignment features) to an input port having a same mode size as the fiber, or other approaches.

The fiber coupler chip 515 comprises optical pathways 530 (e.g., silicon waveguides, silicon nitride waveguides). In some example embodiments, the fiber-to-chip mode converters 510 output the light in a reduced mode size which is maintained as the light propagates through the pathways 530. In some example embodiments, widths of pathways 530 are reduced to reduce the size of the light mode in the fiber coupler chip 515.

In some example embodiments, the fiber coupler chip 515 is free space coupled (e.g., butt coupled, pressed-up-against, locked into place using physical features) to a photonic chip 520 comprising a photonic integrated circuit 545 (e.g., optical components optical modulators, splitters, photodetectors). In some example embodiments, the optical pathways of the fiber coupler chip 515 comprises a plurality of waveguide ports that are free space coupled to a plurality of the input ports of the photonic chip 520. This way, the light can be coupled using a waveguide-to-waveguide interface in which the mode coupling is matched (e.g., 98% matched to 100% mode size match). In the illustrated example embodiment of FIG. 5, the fiber chip coupling system 500 comprises a coupling region 535 in which each of the pathways 530 of the fiber coupler chip 515 is coupled to narrowing waveguide tapers that expand the optical mode size of the light as the light propagates towards the edge of the fiber coupler chip; towards the free space coupling interface 525 (e.g., butt coupling interface).

In some example embodiments, the light in the expanded mode size is then coupled to photonic chip 520 to mode expander components in the photonic chip 520 that are orientated in reverse of the fiber coupler chip mode expanders. The light propagates from the mode expanders to waveguides 540 of the photonic chip that are coupled to a photonic integrated circuit 545. In some example embodiments, the area in the free space coupling interface 525 is empty and the light propagates from the fiber coupler chip 515 to the photonic chip 520 through the empty gap. In some example embodiments, the fiber coupler chip 515 is butt coupled, edge-to-edge, to the photonic chip 520 and a fill is deposited between the two chips, such as an adhesive to better bond the chips and increase the sturdiness of the architecture 500.

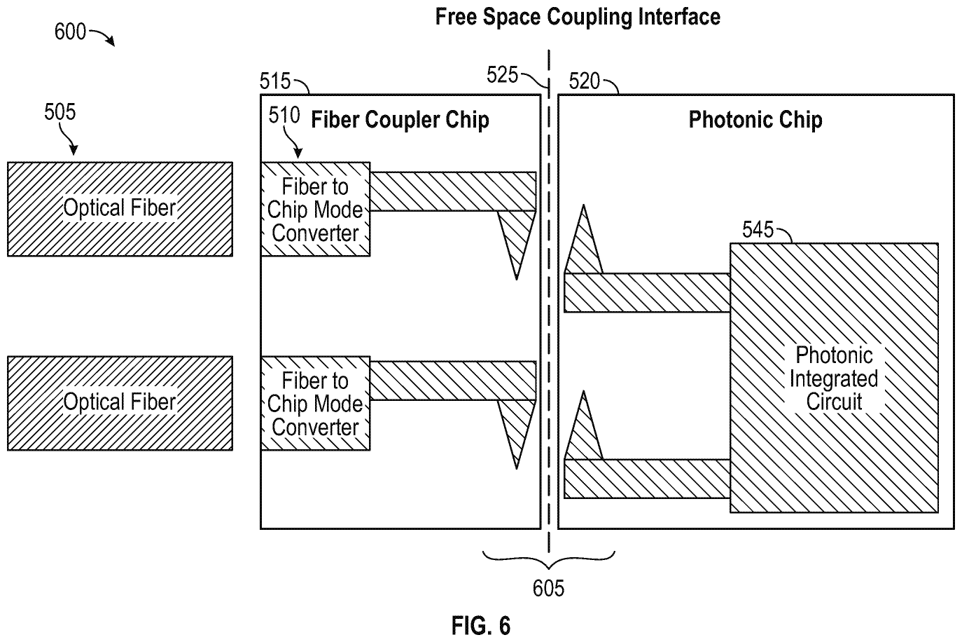

FIG. 6 shows a fiber chip coupling system 600, in accordance with some example embodiments. The example of FIG. 6, the mode expanders are replaced with adiabatic couplers (e.g., tapers) in a adiabatic coupling region 605 in which the waveguides of the fiber coupler chip 515 and the waveguides of the photonic chip 520 are adiabatically coupled to one another using adiabatic tapers in the adiabatic coupling region 605. For example, the light in the fiber coupler chip 515 is adiabatically squeezed out of the fiber coupler chip 515 using adiabatic tapers that are coupled to other adiabatic tapers in the photonic chip.

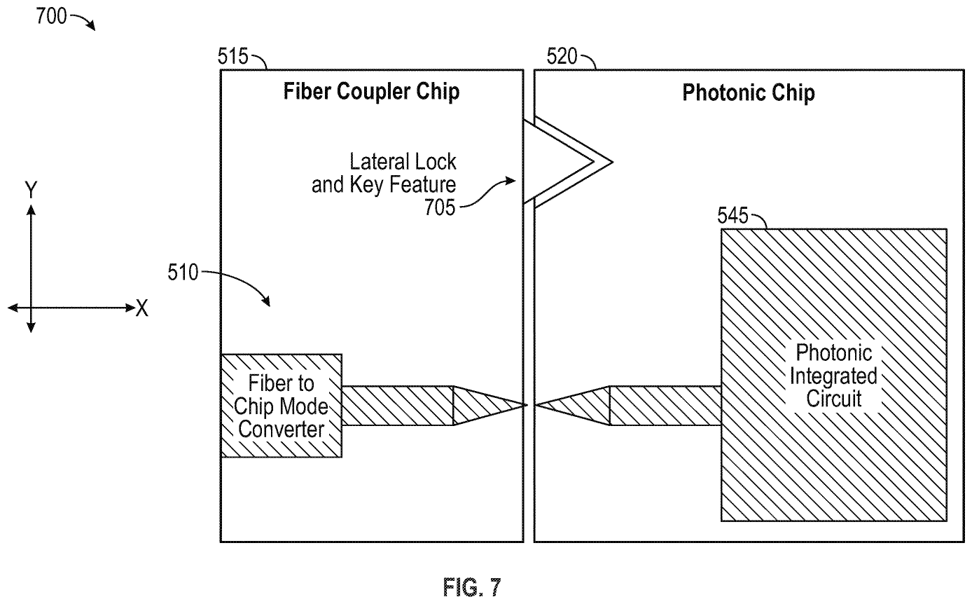

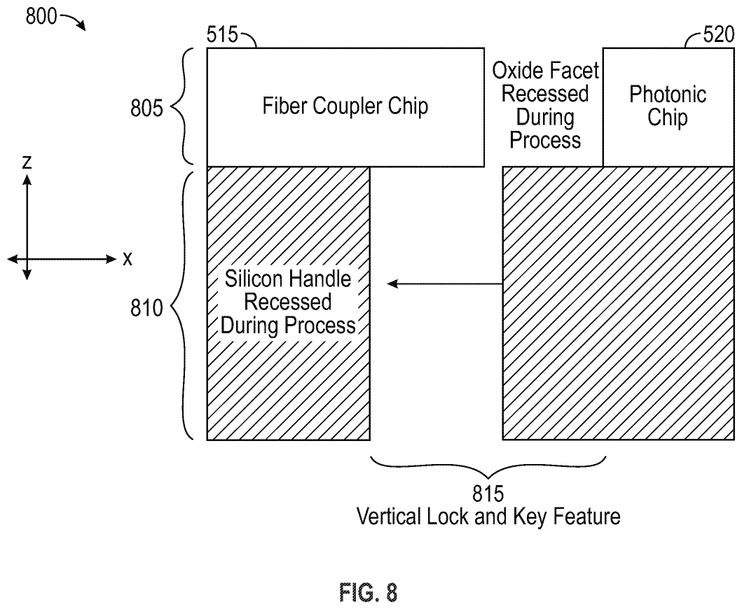

FIGS. 7 and 8 show alignment features for physical registration and alignment of the ports of the fiber coupler chip 515 and the photonic chip 520, in accordance with some example embodiments. FIG. 7 shows a lateral alignment architecture 700, in accordance with some example embodiments. As illustrated, the fiber coupler chip 515 and the photonic chip 520 are laterally aligned (e.g., in the x-axis direction, horizontally) using lateral lock and key features 705. FIG. 8 shows a longitudinal alignment architecture 800, in accordance with some example embodiments. As illustrated in FIG. 8, the fiber coupler chip 515 and the photonic chip 520 can be longitudinally aligned (e.g., in the z-axis direction, vertically) using vertical lock and key features 815. In some example embodiments, the fiber chip 515 and the photonic chip 520 have a silicon handle layer 810 and an oxide layer 805. In some example embodiments, the oxide layer 805 of the photonic chip 520 is recessed during processing and the silicon handle layer 810 of fiber coupler chip is congruently recessed such that the two recessed layers interlock to form the vertical lock and key feature 815.

In some example embodiments, the fiber coupler chip 515 and the photonic chip 520 are manufactured at different manufacturing facilities which recess the different layer parts to form the features 815. For example, the photonic chip 520 is formed from a first oxide layer and wafer handle package where the oxide layer is recessed, and the fiber coupler chip 515 is formed from second different oxide layer and wafer handle package, where the silicon handle region attached to the fiber coupler chip 515 is recessed, after which the structures of the photonic chip 520 can be aligned with the structures of the fiber coupler chip 515 at an assembly location.

In some example embodiments, the fiber coupler chip 515 undergoes processing that is incongruent with the components of the photonic chip 520. For example, the fiber coupler chip 515 may undergo high temperature annealing that would harm or destroy the components of the photonic chip 520 (e.g., single photon detectors, high performance phase shifters). In these example embodiments, the fiber coupler chip 515 can undergo the high temperature processing and then be successfully aligned with interlocked with the fiber coupler chip 515 to couple light (e.g., individual photons) from the fiber coupler chip 515 to the photonic chip 520 in an ultra-low-loss edge-coupled approach.

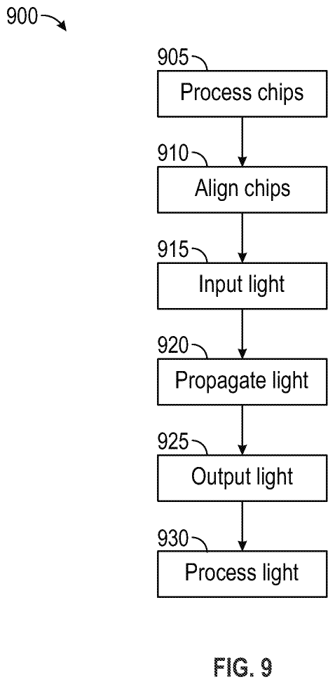

FIG. 9 shows a flow diagram of a method 900 for coupling light from a fiber coupler chip to a photonic integrated circuit, in accordance with some example embodiments. At operation 905, a plurality of chips are processed. For example, in a first manufacturing environment (e.g., fabrication plant) a fiber coupler chip can undergo one or more high temperature manufacturing processes (e.g., high-temp annealing) followed by formation of interlocking features to interlock with coupled-to PICs. Further, in a second manufacturing environment (e.g., a second fabrication plant), a photonic chip can be formed using photonic processing techniques to create sensitive photonic components that would be harmed by the processing of the fiber chip. Further, the photonic chip can be further processed to have interlocking feature that interlock with the photonic integrated circuit.

At operation 910, the chips are aligned. For example, the fiber coupler chip 515 or the photonic chip 520 are physically manipulated to interlock their respective lateral and longitudinal interlocking features to align the output waveguide ports of the fiber coupler chip 515 to the input waveguide ports of the photonic chip 520. In some example embodiments, the photonic chip 520 comprises one or more taps and photodetectors such that bright light can be coupled form the fiber coupler chip 515 to the photonic chip 520 in an active alignment process at operation 920 (e.g., moving the chips physically until the photodetector outputs a maximum value indicating the ports of the respective chips are optically aligned).

At operation 915, light from a plurality of fibers 505 to a fiber coupler chip 515. In some example embodiments, the fibers are coupled and fixed to the fiber coupler chip using one or more different mechanisms available, such as v-grooves, or fusing the fiber to a port of the fiber coupler chip.

At operation 920, light propagates in the fiber coupler chip 515 and the optical mode size is reduced during propagation. In some example embodiments, the fiber coupler chip 515 comprises one or more mode size converters to reduce the light from a large fiber mode size to much smaller waveguide mode size. In some example embodiments, the fiber coupler chip 515 uses integrated waveguides having gradually tapered widths, or other types of spot size converters, to gradually reduce the mode size from the fiber mode size to the waveguide mode size.

At operation 925, the light output from the fiber coupler chip 515 to the photonic chip 520 (e.g., using mode expander-based coupling between the butt coupled chips, using adiabatic couplers between the butt coupled chips).

At operation 930, the light coupled from the fiber coupler chip 515 to the photonic chip 520 is processed using the photonic chip 520. For example, individual photons (e.g., entangled photons) are coupled into the photonic chip 520 and undergo further entanglement operations with other photons (e.g., individual photons, entangled photons).

In the foregoing detailed description, the method and apparatus of the present inventive subject matter have been described with reference to specific exemplary embodiments thereof. It will, however, be evident that various modifications and changes may be made thereto without departing from the broader scope of the present inventive subject matter. The present specification and figures are accordingly to be regarded as illustrative rather than restrictive.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

The following are example embodiments:

Example 1: A method for edge coupling light to a photonic integrated circuit (PIC), the method comprising: coupling, from a plurality of fibers, light to a plurality of fiber ports of a fiber coupler chip, each of the plurality of fibers and the plurality of fiber ports having congruent sizes that match a fiber mode size of the plurality of fibers; propagating the light along optical paths in the fiber coupler chip, the optical paths having widths that decrease in size along the optical paths to reduce the fiber mode size to form a reduced mode size of the light as the light propagates along the optical paths in the fiber coupler chip; and coupling the light from a plurality of fiber coupler chip waveguide ports that are on an edge of the fiber coupler chip to a plurality of PIC waveguide ports that are on another edge of the PIC, the light being coupled from the fiber coupler chip to the plurality of PIC waveguide ports in the reduced mode size that is smaller than the fiber mode size.

Example 2: The method as example 1 describes, wherein the fiber coupler chip is free space coupled to the PIC.

Example 3: The method as either of examples 1 or 2 describe, wherein the light is coupled from the fiber coupler chip to the PIC along a lateral direction, wherein the fiber coupler chip comprises a first lateral alignment feature configured to interlock with a second lateral alignment feature on the PIC to align the fiber coupler chip and the PIC in the lateral direction such that the plurality of fiber coupler chip waveguide ports to a plurality of PIC waveguide ports are aligned in the lateral direction.

Example 4: The method as any of examples 1-3 describe, wherein the plurality of fiber coupler chip waveguide ports to a plurality of PIC waveguide ports are passively aligned by interlocking the first lateral alignment feature of the fiber coupler chip and the second lateral alignment feature of the PIC.

Example 5: The method as any of examples 1-4 describe, wherein the fiber coupler chip comprises a first longitudinal alignment feature that is configured to interlock with a second longitudinal alignment feature of the PIC to align the fiber coupler chip and the PIC in a longitudinal direction such that the plurality of fiber coupler chip waveguide ports and a plurality of PIC waveguide ports are aligned in the longitudinal direction.

Example 6: The method as any of examples 1-5 describe, wherein the method further comprises: activating a light source and a photodetector to perform active alignment of the plurality of fiber coupler chip waveguide ports and the plurality of PIC waveguide ports.

Example 7: The method as any of examples 1-6 describe, wherein the PIC comprises a tap to tap the light from one or more of the plurality of PIC waveguide ports to the photodetector to maximize alignment between the fiber coupler chip and the PIC by maximizing signal from the photodetector from physical adjustments to one or more of: the PIC and the fiber coupler chip.

Example 8: The method as any of examples 1-7 describe, wherein a first coupling interface comprises an optical interface between the plurality of fibers and the plurality of fiber ports of the fiber coupler chip, and wherein a second coupling interface comprises another optical interface between the fiber coupler chip and the PIC.

Example 9: The method as any of examples 1-8 describe, wherein the second coupling interface is a integrated waveguide to integrated waveguide optical coupling interface.

Example 10: The method as any of examples 1-9 describe, wherein the first coupling interface is not a waveguide-to-waveguide coupling interface.

Example 11: The method as any of examples 1-10 describe, wherein the first coupling interface is a fiber-to-waveguide coupling interface.

Example 12: The method as any of examples 1-11 describe, wherein each of the plurality of fiber coupler chip waveguide ports comprises a narrowing taper to expand a size of the reduced mode size as the light propagates in the narrowing taper towards the PIC, the reduced mode size being expanded in size to an expanded mode size for coupling to the PIC.

Example 13: The method as any of examples 1-12 describe, wherein each of the plurality of PIC waveguide ports comprises a widening taper that reduces the expanded mode size of the light to the reduced mode size, wherein the light propagates in the fiber coupler chip in the reduced mode size, and the light propagates in the expanded mode size only in the narrowing taper of the fiber coupler chip and the widening taper of the PIC.

Example 14: The method as any of examples 1-13 describe, wherein the expanded mode size compensates for misalignments between the plurality of fiber coupler chip waveguide ports and the plurality of PIC waveguide ports.

Example 15: The method as any of examples 1-14 describe, wherein the reduced mode size matches a waveguide mode size of waveguides in the PIC.

Example 16: The method as any of examples 1-15 describe, wherein the fiber coupler chip is free space coupled to the PIC and an adhesive layer bonds the fiber coupler chip to the PIC, the light propagating from the fiber coupler chip to the PIC through the adhesive layer.

Example 17: The method as any of examples 1-16 describe, wherein the adhesive layer has an index of refraction that matches the fiber coupler chip and the PIC.

Example 18: The method as any of examples 1-17 describe, wherein the fiber coupler chip to PIC coupling is longitudinal and fiber coupler chip to PIC coupling is lateral edge coupling.

Example 19: The method as any of examples 1-18 describe, wherein the plurality of fibers are coupled to the plurality of fiber ports of a fiber coupler chip using v-grooves.

Example 20: The method as any of examples 1-19 describe, wherein the plurality of fibers are coupled to the plurality of fiber ports of a fiber coupler chip by fusing the fibers to the fiber ports of the fiber coupler chip.

Example 21: The method as any of examples 1-20 describe, wherein the fiber coupler chip and PIC are free space coupled and optical mode matching between waveguides of the plurality of fiber coupler chip waveguide ports and the plurality of PIC waveguide ports of the PIC is greater than 98%.

Example 22: The method as any of examples 1-21 describe, wherein the plurality of fibers each have a mode size of at least 100 microns and the plurality of PIC waveguide ports are waveguides having another mode size of less than 20 microns.

Example 23: The method as any of examples 1-22 describe, wherein the fiber coupler chip undergoes high temperature annealing during fabrication, and wherein the PIC does not undergo high temperature annealing during fabrication.

Example 24: The method as any of examples 1-23 describe, wherein the PIC comprises thin buried oxide layer, and wherein the fiber coupler chip comprises a thick buried oxide layer that is at least five times thicker than the thin buried oxide layer.

Example 25: The method as any of examples 1-24 describe, wherein components of the PIC are sensitive to high temperature anneals above 800 degrees Fahrenheit, and wherein PIC is coupled to the fiber coupler chip after the fiber coupler chip undergoes high temperature annealing, and wherein the fiber coupler chip is formed in a first fabrication environment and the PIC is coupled to the fiber coupler chip at a second fabrication environment.

Example 26: The method as any of examples 1-25 describe, wherein each of the plurality of fiber coupler chip waveguide ports is adiabatically coupled to one of the plurality of PIC waveguide ports of the PIC.

Example 27: The method as any of examples 1-26 describe, wherein the PIC is formed from one or more of: silicon nitride, indium phosphide, and III-V material; wherein the fiber coupler chip is formed from one or more of: silicon nitride, indium phosphide, and III-V material.

Example 28: The method as any of examples 1-27 describe, wherein each of the plurality of fibers is single mode fiber.

Example 29: A fiber coupler chip for coupling light to a photonic integrated circuit (PIC), the fiber coupler chip comprising: a plurality of fiber ports to couple light from a plurality of fibers, each of the plurality of fibers and the plurality of fiber ports having congruent sizes that match a fiber mode size of the plurality of fibers; optical paths that are coupled to the plurality of fiber ports to propagate the light along the optical paths in the fiber coupler chip, the optical paths having widths that decrease in size along the optical paths to reduce the fiber mode size to form a reduced mode size of the light as the light propagates along the optical paths; and a plurality of fiber coupler chip waveguide ports on an edge of the fiber coupler chip, the plurality of fiber coupler chip waveguide ports to output the light to a plurality of PIC waveguide ports on another edge of the PIC, the light being coupled from the fiber coupler chip to the plurality of PIC waveguide output ports in the reduced mode size.

Example 30: The fiber coupler chip as example 29 describes, wherein the fiber coupler chip is free space coupled to the PIC.

Example 31: The fiber coupler chip as either of examples 29 or 30 describe, wherein the light is coupled from the fiber coupler chip to the PIC along a lateral direction, wherein the fiber coupler chip comprises a first lateral alignment feature configured to interlock with a second lateral alignment feature on the PIC to align the fiber coupler chip and the PIC in the lateral direction such that the plurality of fiber coupler chip waveguide ports to a plurality of PIC waveguide ports are aligned in the lateral direction.

Example 32: The fiber coupler chip as any of examples 29-31 describe, wherein the plurality of fiber coupler chip waveguide ports to a plurality of PIC waveguide ports are passively aligned by interlocking the first lateral alignment feature of the fiber coupler chip and the second lateral alignment feature of the PIC.

Example 33: The fiber coupler chip as any of examples 29-32 describe, wherein the fiber coupler chip comprises a first longitudinal alignment feature that is configured to interlock with a second longitudinal alignment feature of the PIC to align the fiber coupler chip and the PIC in a longitudinal direction such that the plurality of fiber coupler chip waveguide ports and a plurality of PIC waveguide ports are aligned in the longitudinal direction.

Example 34: The fiber coupler chip as any of examples 29-33 describe, wherein a light source and a photodetector are implemented to perform active alignment of the plurality of fiber coupler chip waveguide ports and the plurality of PIC waveguide ports.

Example 35: The fiber coupler chip as any of examples 29-34 describe, wherein the PIC comprises a tap to tap the light from one or more of the plurality of PIC waveguide ports to the photodetector to maximize alignment between the fiber coupler chip and the PIC by maximizing signal from the photodetector from physical adjustments to one or more of: the PIC and the fiber coupler chip.

Example 36: The fiber coupler chip as any of examples 29-35 describe, wherein a first coupling interface comprises an optical interface between the plurality of fibers and the plurality of fiber ports of the fiber coupler chip, and wherein a second coupling interface comprises another optical interface between the fiber coupler chip and the PIC.

Example 37: The fiber coupler chip as any of examples 29-36 describe, wherein the second coupling interface is a integrated waveguide to integrated waveguide optical coupling interface.

Example 38: The fiber coupler chip as any of examples 29-37 describe, wherein the first coupling interface is not a waveguide-to-waveguide coupling interface.

Example 39: The fiber coupler chip as any of examples 29-38 describe, wherein the first coupling interface is a fiber-to-waveguide coupling interface.

Example 40: The fiber coupler chip as any of examples 29-39 describe, wherein each of the plurality of fiber coupler chip waveguide ports comprises a narrowing taper to expand a size of the reduced mode size as the light propagates in the narrowing taper towards the PIC, the reduced mode size being expanded in size to an expanded mode size for coupling to the PIC.

Example 41: The fiber coupler chip as any of examples 29-40 describe, wherein each of the plurality of PIC waveguide ports comprises a widening taper that reduces the expanded mode size of the light to the reduced mode size, wherein the light propagates in the fiber coupler chip in the reduced mode size, and the light propagates in the expanded mode size only in the narrowing taper of the fiber coupler chip and the widening taper of the PIC.

Example 42: The fiber coupler chip as any of examples 29-41 describe, wherein the expanded mode size compensates for misalignments between the plurality of fiber coupler chip waveguide ports and the plurality of PIC waveguide ports.

Example 43: The fiber coupler chip as any of examples 29-42 describe, wherein the reduced mode size matches a waveguide mode size of waveguides in the PIC.

Example 44: The fiber coupler chip as any of examples 29-43 describe, wherein the fiber coupler chip is free space coupled to the PIC and an adhesive layer bonds the fiber coupler chip to the PIC, the light propagating from the fiber coupler chip to the PIC through the adhesive layer.

Example 45: The fiber coupler chip as any of examples 29-44 describe, wherein the adhesive layer has an index of refraction that matches the fiber coupler chip and the PIC.

Example 46: The fiber coupler chip as any of examples 29-45 describe, wherein the fiber coupler chip to PIC coupling is longitudinal and fiber coupler chip to PIC coupling is lateral edge coupling.

Example 47: The fiber coupler chip as any of examples 29-46 describe, wherein the plurality of fibers are coupled to the plurality of fiber ports of a fiber coupler chip using v-grooves.

Example 48: The fiber coupler chip as any of examples 29-47 describe, wherein the plurality of fibers are coupled to the plurality of fiber ports of a fiber coupler chip by fusing the fibers to the fiber ports of the fiber coupler chip.

Example 49: The fiber coupler chip as any of examples 29-48 describe, wherein the fiber coupler chip and PIC are free space coupled and optical mode matching between waveguides of the plurality of fiber coupler chip waveguide ports and the plurality of PIC waveguide ports of the PIC is greater than 98%.

Example 50: The fiber coupler chip as any of examples 29-49 describe, wherein the plurality of fibers each have a mode size of at least 100 microns and the plurality of PIC waveguide ports are waveguides having another mode size of less than 20 microns.

Example 51: The fiber coupler chip as any of examples 29-50 describe, wherein the fiber coupler chip undergoes high temperature annealing during fabrication, and wherein the PIC does not undergo high temperature annealing during fabrication.

Example 52: The fiber coupler chip as any of examples 29-51 describe, wherein the PIC comprises thin buried oxide layer, and wherein the fiber coupler chip comprises a thick buried oxide layer that is at least five times thicker than the thin buried oxide layer.

Example 53: The fiber coupler chip as any of examples 29-52 describe, wherein components of the PIC are sensitive to high temperature anneals above 800 degrees Fahrenheit, and wherein PIC is coupled to the fiber coupler chip after the fiber coupler chip undergoes high temperature annealing, and wherein the fiber coupler chip is formed in a first fabrication environment and the PIC is coupled to the fiber coupler chip at a second fabrication environment.

Example 54: The fiber coupler chip as any of examples 29-53 describe, wherein each of the plurality of fiber coupler chip waveguide ports is adiabatically coupled to one of the plurality of PIC waveguide ports of the PIC.

Example 55: The fiber coupler chip as any of examples 29-54 describe, wherein the PIC is formed from one or more of: silicon nitride, indium phosphide, and III-V material; wherein the fiber coupler chip is formed from one or more of: silicon nitride, indium phosphide, and III-V material.

Example 56: The fiber coupler chip as any of examples 29-55 describe, wherein each of the plurality of fibers is single mode fiber.

In the foregoing detailed description, the method and apparatus of the present inventive subject matter have been described with reference to specific exemplary embodiments thereof. It will, however, be evident that various modifications and changes may be made thereto without departing from the broader scope of the present inventive subject matter. The present specification and figures are accordingly to be regarded as illustrative rather than restrictive.

What is claimed is:

1. A method for edge coupling light to a photonic integrated circuit (PIC), the method comprising:
coupling, from a plurality of fibers, light to a plurality of fiber ports of a fiber coupler chip, each of the plurality of fibers and the plurality of fiber ports having congruent sizes that match a fiber mode size of the plurality of fibers;
propagating the light along optical paths in the fiber coupler chip, the optical paths having widths that decrease in size along the optical paths to reduce the fiber mode size to form a reduced mode size of the light as the light propagates along the optical paths in the fiber coupler chip, and
coupling the light from a plurality of fiber coupler chip waveguide ports that are on an edge of the fiber coupler chip to a plurality of PIC waveguide ports that are on another edge of the PIC, the light being coupled from the fiber coupler chip to the plurality of PIC waveguide ports in the reduced mode size that is smaller than the fiber mode size.

2. The method of claim 1, wherein the light is coupled from the fiber coupler chip to the PIC along a lateral direction, wherein the fiber coupler chip comprises a first lateral alignment feature configured to interlock with a second lateral alignment feature on the PIC to align the fiber coupler chip and the PIC in the lateral direction such that the plurality of fiber coupler chip waveguide ports to a plurality of PIC waveguide ports are aligned in the lateral direction.

3. The method of claim 2, wherein the fiber coupler chip comprises a first longitudinal alignment feature that is configured to interlock with a second longitudinal alignment feature of the PIC to align the fiber coupler chip and the PIC in a longitudinal direction such that the plurality of fiber coupler chip waveguide ports and a plurality of PIC waveguide ports are aligned in the longitudinal direction.

4. The method of claim 1, wherein a first coupling interface comprises an optical interface between the plurality of fibers and the plurality of fiber ports of the fiber coupler chip, and wherein a second coupling interface comprises another optical interface between the fiber coupler chip and the PIC.

5. The method of claim 4, wherein the second coupling interface is a integrated waveguide to integrated waveguide optical coupling interface.

6. The method of claim 4, wherein the first coupling interface is a fiber-to-waveguide coupling interface.

7. The method of claim 1, wherein each of the plurality of fiber coupler chip waveguide ports comprises a narrowing taper to expand a size of the reduced mode size as the light propagates in the narrowing taper towards the PIC, the reduced mode size being expanded in size to an expanded mode size for coupling to the PIC.

8. The method of claim 7, wherein each of the plurality of PIC waveguide ports comprises a widening taper that reduces the expanded mode size of the light to the reduced mode size, wherein the light propagates in the fiber coupler chip in the reduced mode size, and the light propagates in the expanded mode size only in the narrowing taper of the fiber coupler chip and the widening taper of the PIC.

9. The method of claim 8, wherein the expanded mode size compensates for misalignments between the plurality of fiber coupler chip waveguide ports and the plurality of PIC waveguide ports.

10. The method of claim 1, wherein the fiber coupler chip to PIC coupling is longitudinal and fiber coupler chip to PIC coupling is lateral edge coupling.

11. The method of claim 1, wherein the plurality of fibers each have a mode size of at least 100 microns and the plurality of PIC waveguide ports are waveguides having another mode size of less than 20 microns.

12. The method of claim 1, wherein each of the plurality of fiber coupler chip waveguide ports is adiabatically coupled to one of the plurality of PIC waveguide ports of the PIC using tapers.

13. A fiber coupler chip for coupling light to a photonic integrated circuit (PIC), the fiber coupler chip comprising:
a plurality of fiber ports to couple light from a plurality of fibers, each of the plurality of fibers and the plurality of fiber ports having congruent sizes that match a fiber mode size of the plurality of fibers;
optical paths that are coupled to the plurality of fiber ports to propagate the light along the optical paths in the fiber coupler chip, the optical paths having widths that decrease in size along the optical paths to reduce the fiber mode size to form a reduced mode size of the light as the light propagates along the optical paths; and
a plurality of fiber coupler chip waveguide ports on an edge of the fiber coupler chip, the plurality of fiber coupler chip waveguide ports to output the light to a plurality of PIC waveguide ports on another edge of the PIC, the light being coupled from the fiber coupler chip to the plurality of PIC waveguide ports in the reduced mode size.

14. The fiber coupler chip of claim 13, wherein the light is coupled from the fiber coupler chip to the PIC along a lateral direction, wherein the fiber coupler chip comprises a first lateral alignment feature configured to interlock with a second lateral alignment feature on the PIC to align the fiber coupler chip and the PIC in the lateral direction such that the plurality of fiber coupler chip waveguide ports to a plurality of PIC waveguide ports are aligned in the lateral direction.

15. The fiber coupler chip of claim 14, wherein the fiber coupler chip comprises a first longitudinal alignment feature that is configured to interlock with a second longitudinal alignment feature of the PIC to align the fiber coupler chip and the PIC in a longitudinal direction such that the plurality of fiber coupler chip waveguide ports and a plurality of PIC waveguide ports are aligned in the longitudinal direction.

16. The fiber coupler chip of claim 13, wherein a first coupling interface comprises an optical interface between the plurality of fibers and the plurality of fiber ports of the fiber coupler chip, and wherein a second coupling interface comprises another optical interface between the fiber coupler chip and the PIC.

17. The fiber coupler chip of claim 16, wherein the second coupling interface is a integrated waveguide to integrated waveguide optical coupling interface.

18. The fiber coupler chip of claim 16, wherein the first coupling interface is a fiber-to-waveguide coupling interface.

19. The fiber coupler chip of claim 13, wherein each of the plurality of fiber coupler chip waveguide ports comprises a narrowing taper to expand a size of the reduced mode size as the light propagates in the narrowing taper towards the PIC, the reduced mode size being expanded in size to an expanded mode size for coupling to the PIC.

20. The fiber coupler chip of claim 19, wherein each of the plurality of PIC waveguide ports comprises a widening taper that reduces the expanded mode size of the light to the reduced mode size, wherein the light propagates in the fiber coupler chip in the reduced mode size, and the light propagates in the expanded mode size only in the narrowing taper of the fiber coupler chip and the widening taper of the PIC.
